(19) United States
(12) Patent Application Publication
(10) Pub. No.: US 2006/0002117 A1
(43) Pub. Date: Jan. 5, 2006

(54) LIGHTING BULB WITH MAGNETIC SUPPORT

(76) Inventor: Laurentiu Neacsu, Bucharest (RO)

Correspondence Address: HERSHKOVITZ & ASSOCIATES, 1725 I STREET NW, SUITE 300, WASHINGTON, DC, 20006, US

(21) Appl. No.: 11/160,250

(22) Filed: Jun. 15, 2005

(30) Foreign Application Priority Data
Jul. 2, 2004 (RO) 2004-00607

(51) Int. Cl. F21V 19/00

(52) U.S. Cl. 362/382

(57) ABSTRACT

A lighting body with magnetic support assembled in various rooms in different positions and places. As a chandelier, the lighting body includes a fastening case that is hung from the ceiling. Several arms extend from the fastening case, each equipped with permanent magnets. Confronting and juxtaposed to the permanent magnets are several lighting bulbs, also carrying permanent magnets and bulbs. The permanent magnets have opposite polarity such that they attract and their spacing is determined by the length of the current carrying wires to create the impression that the lighting bulbs are suspended. The lighting body can be produced in a variety of forms such as a chandelier, a suspended wall bracket, floor lamp or reading lamp. Because the magnets are adjustably positioned, it is possible to change the design of the lamp and the orientation of the bulbs.

### CROSS-REFERENCE TO RELATED APPLICATIONS

The present application claims priority under 35 U.S.C. § 119 to Romanian Patent Application No. 2004 00607, filed on Jul. 2, 2004, the disclosure of which is expressly incorporated by reference herein in its entirety.

### BACKGROUND OF THE INVENTION

1. Field of the Invention

The invention relates to a lighting body or lamp with magnetic support which may be placed in different locations in various rooms in different orientations.

2. Discussion of Background Information

Lighting bodies are known in a variety of forms. Chandeliers are hung from the ceiling and have one or several arms fixed to a central support and traversed by current supplying wires. Each bulb is mounted on an arm and has a shade fixed to it by screws or clamps. Also known are lamps in the form of brackets, with a base fixed on the wall and one or several arms fixed in the base at one end and with bulbs at the other end, shaded or not. Wiring passes through the support and the arms. These lamps have the disadvantage of being simplistic and non-adjustable, limiting their artistic arrangement and adaptability to the location.

Efforts have been made to use magnetism in light system supports to enable minor adjustments. In U.S. Pat. No. 4,9656,708 to Louis, an entire gooseneck lamp is attached to any metallic surface by a magnet at its base. Various lighting systems have used direct magnetic contact to adjustably orient components. In Zingone, U.S. Pat. No. 2,695,950, a light bulb is held within a metallic globe or shade held by direct contact with a magnet on a base, enabling the globe to be adjustably oriented. Similarly, U.S. Pat. No. 5,145,509 to Wulfman et al, uses magnets to adjustably locate and electrically connect track lighting fixtures along a ceiling track. In U.S. Pat. No. 4,719,549 to Apel, magnetic attraction is used in conjunction with the friction of a ball and socket joint to connect and retain lamp support rods in adjustable orientations. More whimsically, in Jean et al, U.S. Pat. No. 5,154,501, a fluorescent ball floats above a light bulb within a shade due to the opposite magnetic polarity of the shade and ball. U.S. Pat. No. 4,997,403 to Akman, utilizes balloons filled with a lighter than air gas to enclose and suspend the light against a tether provided by electrical line cords.

All of these known lighting systems have limited application, requiring specialized support surfaces or rigid mechanical linkages. Simple adjustment of the light itself within the lamp or lighting system to provide artistic and adaptable arrangements have not been possible

### SUMMARY OF THE INVENTION

The lighting system according to the invention, overcomes the disadvantages of the known solutions using magnetic, suspended support. A light bulb, or bulb and shade assembly, includes a permanent magnet. On a spaced support, another oppositely polarized permanent magnet is attached. The distance between magnets, the one fixed inside the light assembly and the other fixed on the support, is limited by the length of the current carrying wire or cord such that the attraction force gives the appearance that the lighting bulb is in suspension. The bulb is tethered to the base support by its wire and drawn toward the spaced magnet support by the attraction of oppositely polarized magnets. The magnets and the light assembly, by their placement, allow the construction of different kinds of lamps such as chandeliers, wall brackets, etc. By repositioning the magnets on the spaced support, different lamp designs are possible using the same components. The materials selected to construct the light assembly and its wires, are as light and fine as possible to give the appearance of free suspension of the light.

The lamp according to the invention has the following advantages:
simple assembly, with no excess components;
easy change of the design and bulb arrangement; and
easy maintenance and quick cleaning.

The electrical lighting body of the invention includes upper and lower vertically spaced supports and a light assembly between them on a flexible tether. At least one of the upper support and the light assembly including a magnet; and the other of the upper support and light assembly includes a magnetically attracted element such that the light assembly is attracted toward the upper support by magnetic attraction to the limit of the restraint provided by the length of the tether.

The magnet, according to the invention, may be a permanent magnet and the magnetically attractive element is embodied as another permanent magnet of opposite polarity. According to the present invention, there is utilized an electric bulb and an electrical current carrying wire as the tether.

The upper support, according to the invention, may comprise a case with laterally extending arms connected to and positioned above arms which define the lower support by rigid structure such that the wire extends from the case to the lower structure and from the lower structure to the light assembly. The lighting body can take the form of a chandelier with a hook for attachment to a ceiling.

The arm of the upper support structure may comprise a pair of arms extending in parallel, and having a series of notches along their length for selectively receiving a permanent magnet.

In a particular form of the invention, the case is secured to the upper end of an axle, the lower end of the axle being rigidly affixed to a base support. Intermediate the case and the base support, horizontally extending arms are provided to which the wire is attached.

In order to provide an adjustable aspect of the lighting system, the lower support arm may have a channel in which the wire is movable. A reel or spool can be used to adjust the length of the wire extending in the channel and thus determine the length of the tether for the light assembly.

According to another aspect of the invention, the upper support structure may be a ceiling, and the magnet may be received in a recess of the ceiling by being attached to outwardly extending wings which rest on the upper surface of the ceiling panels themselves.

The lighting system may be used as a floor or reading lamp, which includes a frame with vertical and horizontal elements. The horizontal element has a permanent magnet. The light assembly is tethered by its electrical wire to a case defined by a base piece which rests on the supporting surface beneath the horizontal element such that the light is drawn upwardly by magnetic attraction to the extent of the tethering wire attached to the base piece. The base piece provides a case for receiving wire and a plug which extend from the base piece to a convenient electrical receptacle.

The lighting body according to the invention may comprise a globe with an electrical socket and a bulb held by the socket and electrically connected to the wire tether. The interior surface of the globe also carries a permanent magnet. For convenience, the globe may be constructed in two parts, threaded or otherwise joined, and may also include openings for ventilation.

As an additional security measure, rings may encircle the wire and may be attached to the lower support by bars, such that in the event of an interruption of the magnetic attraction, the light assembly will be held by its tethering wire supported in the ring.

According to the invention, the light assembly may be suspended and sustained by the magnetic attraction of oppositely polarized magnets, one magnet on the light assembly and another on an upper support structure. The light assembly may be suspended and sustained between the upper and lower support structures.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 is a perspective view of the lighting body with magnetic support assembled as a chandelier;

FIG. 2 shows a second embodiment of the light body attached to a wall;

FIG. 3 is a sectional view of the light body taken on line A-A in FIG. 2;

FIG. 4 shows the shade in cross section;

FIG. 5 shows a lighting body support with an adjustable length wire;

FIG. 6 is a plan view of the supporting magnet fixed to a ceiling;

FIG. 7 is a plan view of a light assembly embodied as a reading lamp;

FIG. 8 is a two dimensional view of a lamp with two bulbs;

FIG. 9 is a view of the lamp with two inclined bulbs;

FIG. 10 is is a view of a lamp with three bulbs;

FIG. 11 is a perspective view of a lighting body with the magnet supported on paired arms;

FIG. 12 is a plan view of the lighting body of FIG. 11; and

FIG. 13 is a view of a lighting bulb and shade assembly.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In a first embodiment of the invention illustrated in FIG. 1, a chandelier includes a fixing case 1 suspended from the ceiling by a hook 2. Electrical power is supplied by wires 3 entering the fixing case and extending to supply bulbs A. From the fixing case 1, arms 4 (two in this example) extend to mount permanent magnets 5 at different distances. The lighting bulbs A are positioned relative to magnets 5 from the arms 4 as determined by the length of conducting wires 6 and structures 7 and 8 traversed by the wires 6. The number of wires correspond to the number of lighting bulbs A.

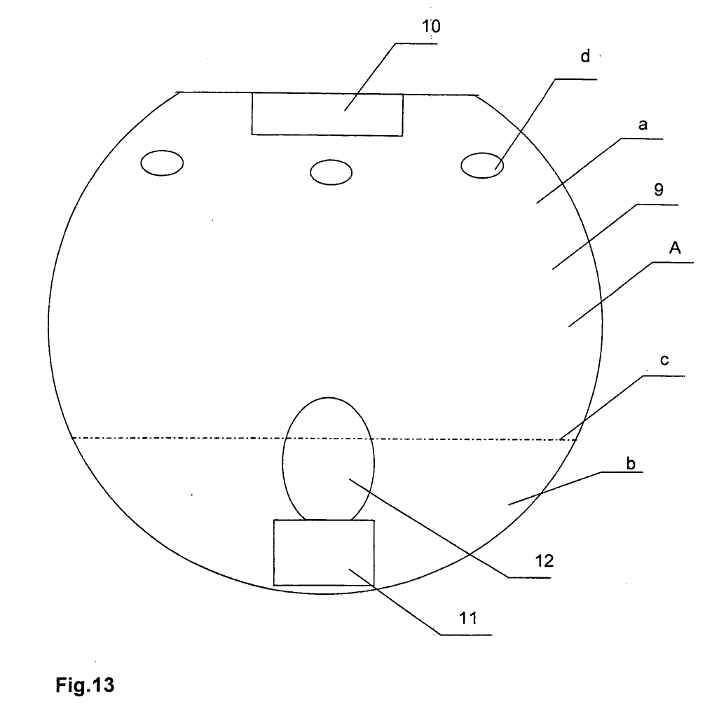

The lighting bulb A (best seen in FIG. 13) is composed of a globe 9 inside of which is a permanent magnet 10 and a socket 11. The socket receives a bulb 12. In order to assemble the internal components, the globe 9 is formed of two parts a and b fixed together with threads at c or other known systems. For ventilation, the globe 90 includes openings d.

The permanent magnet 10 of the lighting bulb A and the permanent magnet 5 on the arms must be positioned such that between their poles there is an attracting force. The distance e between the lighting bulb A and the arm 4 is determined by the length of wires such that the lighting bulb A is sustained by magnetic force between the two magnets 5 and 10 without contact, tethered by the wire 6, giving the impression that the lighting bulb A is suspended. The structure formed by the elements 4, 7 and 8 must be rigid in order to maintain the distance e constant, otherwise there is the risk of collapse and damage of the lighting bulbs A. The elements sustained by the magnetic force, lighting bulbs A and the wires 6, must be made from materials that are as light as possible.

The position of the permanent magnets 5 on the arms 4 might be changed such that the design of the lighting body could change periodically, giving a special effect and continual variation.

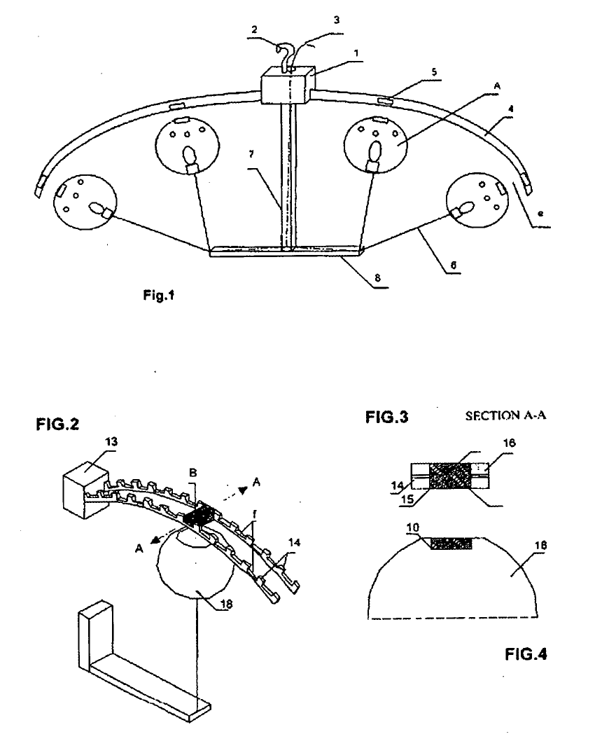

In another embodiment as shown in FIGS. 2, 3 and 4, the lighting body may be fixed to a wall. A fixing case 13 rigidly mounts two arms 14 in parallel. The arms 14 have notches f symmetrically disposed and face to face on the two arms. In the notches f are placed magnetic elements B. The magnetic elements have a metallic case with a permanent magnet 15 and metal wings 16 for guiding and positioning. The magnetic elements B are positioned in the notches f to attract the magnet in the light bulb or shade and suspend the light bulb assembly in the orientation desired. The inside of the shade is organized in the same way as the lighting bulbs with the permanent magnet 10 positioned toward the magnetic element B and with the poles placed such that between them there is a n attracting force. On the arms 14 there may be placed several magnetic elements B.

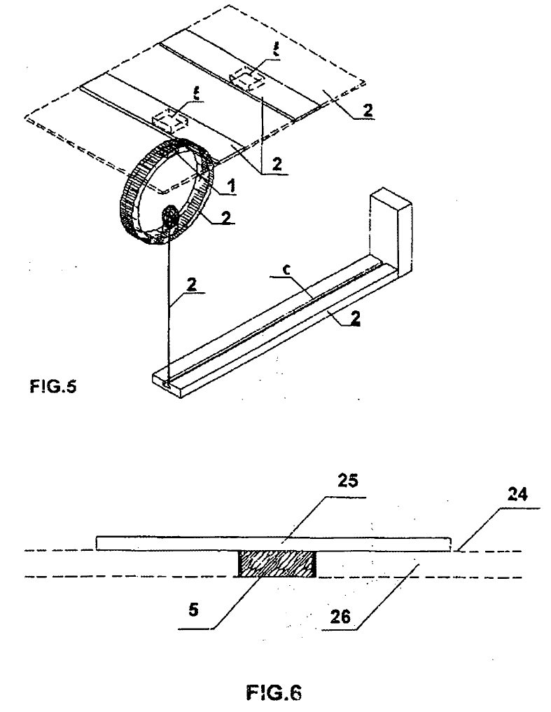

In the embodiment of FIGS. 5 and 6, the magnet is secured to the ceiling and the suspending wire is regulated in length. Magnet 5 is carried by fixing wings 25 and received in a recess in the ceiling panel 26. Beneath the ceiling, an arm 27 is mounted with a channel g. Within the channel, a wire 28 is movable such that it is possible to position a lamp 29 with a permanent magnet carrier 10 in the desired location. The length of the wire 28 may be regulated with a well known spool or reel, not shown in the figure.

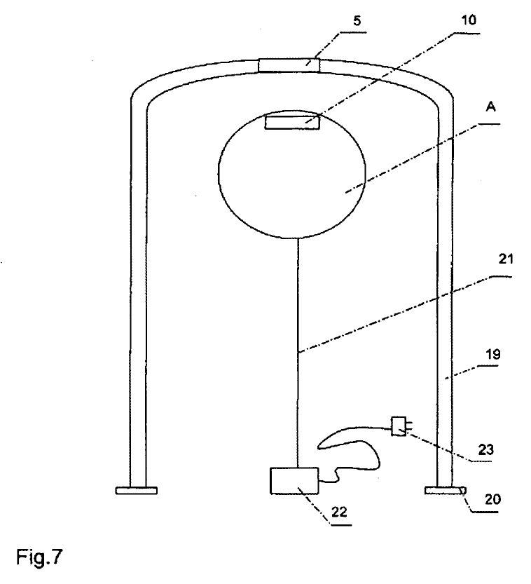

A reading lamp or floor lamp, shown in FIG. 7, includes a frame 19 with several supports 20 and a permanent magnet 5 in the upper side. In the middle of the frame 19 is positioned a lighting bulb A equipped with a magnet 10 which is spaced relative to magnet 5 due to the length of a wire 21 fixed in a piece 22 for connection and distribution. The connection to the electrical supply is by a plug 23.

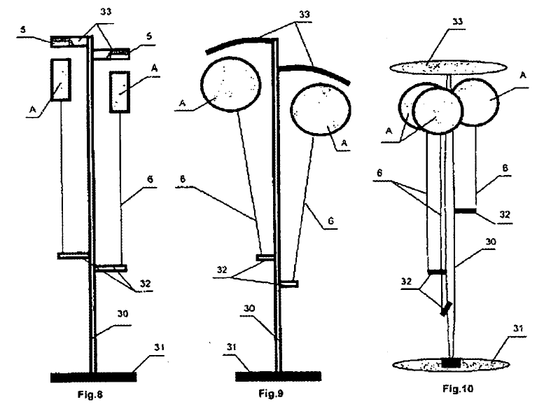

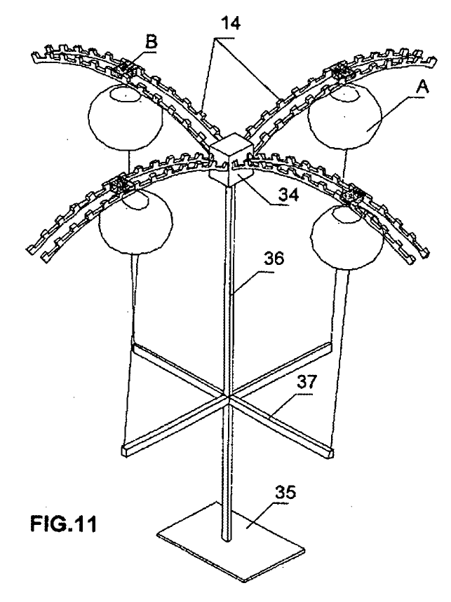

In other embodiments as shown in FIGS. 8, 9 and 10, the lighting bulbs A may be positioned in different configurations around a central support 30 fixed in a base support 31. From the central supports 30, wings 32 extend at different heights and configurations. The lighting bulbs A are attached to the wings by wire 6. The permanent magnets inside the lighting bulbs A and the magnets 5 in the upper arms 33 create the suspension and the desired shape of the lighting body. Arm 33 may be of a variety of shapes.

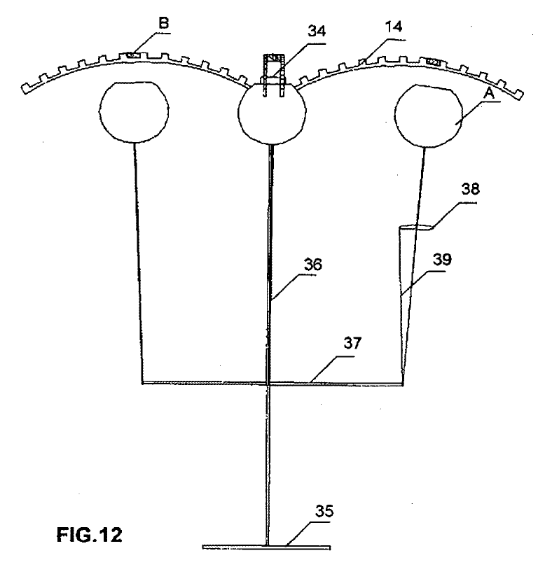

In another embodiment shown in FIGS. 11 and 12, the lighting body has several symmetrical pairs of arms 14 fixed in a central case 34 that distributes the electric power. The arms are sustained by an axle 36 attached to a support 35. To position the lighting bulbs A relative to the magnetic elements B, several arms 37 are fixed to the axle, with their length equal to half the length of the arms 14. Also shown in FIG. 12, in order to avoid damage due to an incidental interruption of the magnetic positioning (due to touching, earthquake, etc.), between the lighting bulbs A and the fixing elements for the magnet carrier 5, it is possible to mount security rings 38 on the supports, sustained by bars 39, to stop and catch the bulbs from falling and thus avoid their damage. The rings 38 and the bars 39 may be angularly oriented relative to the power supply wire.

The supporting elements should be rigid and the lighting bodies should be manufactured from material as light as possible in order to facilitate and regulate the spacing due to the magnetic force. Also, in order to avoid electrical interference with other electric apparatus, it is possible to include magnetic shields.

The principle of the invention is based on the force of attraction of the two permanent magnets, placed on the lighting body and the support. This principle can be applied to a wide variety of lighting bodies in different designs. The assembly of the lighting bodies according to the invention allows the continuous modification of the design.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An electrical lighting body providing illumination comprising:
an upper support;
a lower support vertically spaced a distance beneath said upper support;
a light assembly including a source of illumination;
said light assembly being attached to said lower support by a flexible tether with a length less than said distance;
at least one of said upper support and said light assembly including a magnet;
the other of said upper support and said light assembly including a magnetically attracted element;
whereby said light assembly is attracted toward said upper support by magnetic attraction to the limit of the restraint provided by the length of said tether such that said light assembly is suspended and sustained between the upper and lower supports.

2. An electrical lighting body according to claim 1, wherein said magnet is a permanent magnet.

3. An electrical lighting body according to claim 2, wherein each of said upper support and said light assembly includes a permanent magnet of opposite polarities.

4. An electrical lighting body according to claim 1, wherein said source of illumination is an electric bulb and said tether is an electrical current carrying wire.

5. An electrical lighting body according to claim 4, wherein said upper support comprises a case and at least one arm extending laterally from the case;
said lower support is secured beneath and is interconnected with said case by rigid structure;
said case receives said wire, and
said wire extends from the case to said lower structure and from said lower structure to said light assembly.

6. An electrical lighting body according to claim 5, wherein said lighting body is a chandelier, and wherein said case includes a mechanism for suspending said chandelier from a ceiling.

7. An electrical lighting body according to claim 6, wherein said mechanism for suspending comprises a hook.

8. An electrical lighting body according to claim 5, wherein said at least one arm includes a permanent magnet.

9. An electrical lighting body according to claim 4, further comprising:
said upper support including a pair of arms extending from a case in parallel;
each of said pair of arms including a series of notches extending along its length and juxtaposed to the notches in the adjacent arm of the pair;
said magnet being held in a case having wings which engage in opposed said notches,
whereby said magnet can be selectively located and repositioned in opposed notches along the length of said pair of arms.

10. An electrical lighting body according to claim 9, wherein said case is secured to a wall.

11. An electrical lighting body according to claim 9, wherein said case is secured to the upper end of an axle;
the lower end of the axle being rigidly affixed to a base support; and
said lower support comprising a generally horizontally extending arm to which said wire is attached.

12. An electrical lighting body according to claim 11, wherein
said case carries a plurality of said pairs of arms, and
a corresponding number of said generally horizontal arms are positioned vertically beneath said pairs of arms,
whereby each of said light assemblies are suspended at the end of their wire tether between an upper pair of arms and said generally horizontally extending arm.

13. An electrical lighting body according to claim 4, further comprising:
a vertically extending axle;
said upper support comprising upper arms extending outwardly from an upper region of said axle; and
said lower support comprising wings extending radially outwardly from an intermediate area of said axle.

14. An electrical lighting body according to claim 4, further comprising:
said lower support being a horizontally extending arm;
said arm having a channel extending along its length; and
said wire movably passing through said channel to adjustably determine the tethering length extending out of said arm,
whereby the height of the light assembly and its distance from the horizontally extending arm is adjustable.

15. An electrical lighting body according to claim 4, wherein
said upper support structure is a ceiling, the ceiling being formed from panels having a thickness;
a recess extending through the ceiling panel;
said magnet being attached at an upper surface thereof to an outwardly extending wing; and
said magnet being received in said recess and said wing abutting an upper surface of said ceiling panel to support the magnet from the ceiling.

16. An electrical lighting body according to claim 4, wherein said upper support is provided on a horizontal member of a frame;
the frame including at least one vertical member supporting said horizontal member, the lower end of said vertical member being in turn supported on a horizontal planar surface;
said lower support is provided by a base piece for connection and distribution, the wire extending therefrom to said light assembly; and
said base piece being placed on the horizontal planar surface beneath said horizontal member.

17. An electrical lighting body according to claim 16, wherein a plug is connected to said base piece for receiving electric current.

18. An electrical lighting body according to claim 4, wherein
said light assembly comprises a globe;
an electrical socket is positioned within said globe and is connected to said wire;
a bulb is inserted in said socket; and
a permanent magnet is attached to the inner surface of said globe.

19. An electrical lighting body according to claim 18, further comprising ventilation openings in said globe.

20. An electrical lighting body according to claim 18, wherein said globe is constructed of two parts removably connected to allow access to the interior of the globe.

21. An electrical lighting body according to claim 4, further comprising security rings encircling the wire and attached to the lower support by bars.

22. A method of illumination comprising:
providing an upper support structure;
attaching to said upper support structure a first permanent magnet;
providing a lower supper structure;
attaching a light assembly to the lower support structure with a flexible tether;
securing a second permanent magnet of opposite polarity to said light assembly,
wherein said light assembly is attracted toward said upper support structure by magnetic attraction to the limit of the restraint provided by the length of said tether such that said light assembly is suspended and sustained between the upper and lower support structures.

23. A lamp having adjustably oriented and magnetically sustained light bulb assemblies comprising:
a base support;
an axle extending generally vertically upward from said base support;
said axle including at its upper end a central case;
a plurality of pairs of upper parallel arms extending outwardly and generally horizontally from said case;
each said pair of arms including multiple pairs of notches laterally aligned and opposed;
a first permanent magnet secured within a case, the said case including laterally extending wings, the wings being received in selected opposing notches to mount the first magnet between the arms in the pair;
lower arms extending outwardly from an intermediate area of said axle beneath and in a common vertical plane with said upper parallel arms;
a flexible electric wire extending from each said lower arm and attached at its end to a light assembly;
said light assembly including a globe and an electric socket within said globe;
an electric light bulb received in said socket;
a second permanent magnet attached to the interior of said globe; and
said first and said second magnets having opposite polarity, such that they are attracted to each other,
whereby the light assembly is suspended between the upper and lower arms by the mutual attraction of said magnets and is restrained by the length of said wire, and the position of said light assembly and the angle between the wire and the lower arm is determined by selective location of said first permanent magnet in one of said multiple pairs of notches.
